(19) United States
(12) Patent Application Publication
(10) Pub. No.: US 2004/0214551 A1
(43) Pub. Date: Oct. 28, 2004

(54) Digital mobile telephone and methods for executing and providing multimerdia data for the digital mobile telephone

(76) Inventor: Doo-Yong Kim, Seoul (KR)

Correspondence Address: Powell Goldstein, Frazer & Murphy, PO Box 97223, Washington, DC, 20090-7223, US

(21) Appl. No.: 10/258,990

(22) PCT Filed: May 4, 2001
(86) PCT No.: PCT/KR01/00730

(30) Foreign Application Priority Data
May 9, 2000 (KR) 2000/24702

(51) Int. Cl. H04Q 7/20

(52) U.S. Cl. 455/412.1; 455/414.1

(57) ABSTRACT

A digital mobile telephone includes a multimedia data decoder that processes the multimedia data and distributes the processed multimedia data to corresponding one of multimedia data reproducing and outputting meas. The multimedia data is of a format having a header field which comprises a general information sub-field for indicating data total size and a version of each multimedia data file, a media information sub-field for identifying various multimedia data files, a manipulation information sub-field for describing how to process each of the multimedia data files, and a data information sub-field for indicating positions of each of the multimedia data files. The multimedia data reproducing and outputting means comprises a loudspeaker for voice data, a display screen for image data, an odor-emitting device, a light emitting device, a buzzer, a vibrator and a decipher for deciphering the multimedia data when the multimedia data is encrypted.

### BACKGROUND OF THE INVENTION

1. Field of the Invention

This invention relates to mobile communication technology, and more particularly, a digital mobile telephone that can process multimedia data, and methods for executing and providing multimedia data for the digital mobile telephone.

2. Description of the Related Art

FIG. 1 is a block diagram of a conventional digital mobile telephone. The processing of voice data and text data in the digital mobile telephone of prior art is described below.

A radio frequency signal received through an antenna 700 from a base station (not shown) is transferred to a duplexer 600 and changed to digital signal by a RF receiver 1400. When the digital signal is text data, it is stored in an electronic text mailbox or is displayed on an LCD after processing by a channel decoder 1300. If the digital signal is voice data, it is outputted to a loud speaker or an earphone 1500 through a voice decoder 1700 and a D/A converter 1600. For transmitting voice data, voice signal inputted via a microphone 100 is processed by an A/D converter 200, a voice encoder 300, a channel encoder 400, and a RF transmitter. In transmission of text data, a keypad 1000 is used to interface input text data and the channel encoder 400 and the RF transmitter 500 transmits the text data.

As an example of prior art, U.S. Pat. No. 5,799,091 entitled “Single chip solution for multimedia GSM mobile station systems” discloses a single chip solution for multimedia GSM (Groupe Special Mobile) mobile station. In this patent, a single chip CMOS technology architecture is used to implement all or various combinations of GSM functions such as baseband radio transmission, baseband interface and filtering, source coding, source interfaces and filtering, control and supervision, power and clock management, keyboard and display drivers, memory management, code compaction, digital signal processing, DSP memory, and radio interface. Further, U.S. Pat. No. 5,926,624 entitled “Digital information library and delivery system with logic for generating files targeted to the playback device” discloses an information providing system that comprises a library server having a plurality of digital information files, a client computer system coupled to the library server over a network and a mobile device removably connected to the client computer system. The client computer system includes logic for requesting a download of a selected one or more of the digital information files from the library server and logic for downloading the selected one or more of the digital information files to the mobile device.

In the prior art, data input and output of the conventional digital mobile telephone are independently performed in the form of voice data, text data, or a data through a part of the input/output terminals of the mobile telephone. Therefore, data processing using an integrated multimedia data format is needed for ever-increasing multimedia communication environment.

### SUMMARY OF THE INVENTION

The purpose of the present invention is to provide an integrated multimedia data format suitable for use in multimedia communication environment and a digital mobile telephone and a method for the multimedia data processing.

Other purpose of this invention is to provide a method for executing and processing multimedia data in the digital mobile telephone.

Anther purpose of this invention is to provide a method for providing multimedia data for the digital mobile telephone.

According to one aspect of the present invention, the digital mobile telephone for reproducing multimedia data includes a multimedia data decoder that processes the multimedia data and distributes the processed multimedia data to corresponding one of multimedia data reproducing and outputting means. The multimedia data is of a format for the presentation of the multimedia data offering technical features of indicating the total size as well as the version of each multimedia data file, and of identifying various multimedia data files based on media information contained in the multimedia data. Further, the multimedia data contains a manipulation information describing how to process each of the multimedia data files. The multimedia data reproducing and outputting means comprises a loudspeaker for voice data, a display screen for image data, an odor-emitting device, a light emitting device, a buzzer, a vibrator, and a decipher for deciphering the multimedia data when the multimedia data is encrypted.

According to other aspect of the present invention, the method for providing multimedia data contents for use in a digital mobile telephone includes the preparation of multimedia data contents of a format having a header field and a payload field having a plurality of multimedia data, said header field having a general information sub-field for indicating data total size and a version of each multimedia data file, a media information sub-field for identifying various multimedia data files, a manipulation information sub-field for describing how to process each of the multimedia data files, and a data information sub-field for indicating positions of each of the multimedia data files. When a data provider receives a request for the multimedia data contents from a plurality of digital mobile telephone users, the provider receives and processes the users' information from the requesting digital mobile telephone, and supplies a selection function for the digital mobile telephones to choose at least one of the multimedia data contents.

According another aspect of the present invention, the method for executing multimedia data contents in a mobile telephone includes a step of searching and selecting the multimedia data contents. The execution of the selected multimedia data contents is paused when a call request by a base station occurs during the execution. If the call is over, it is decided whether execution is resumed or not.

### BRIEF DESCRIPTION OF THE DRAWINGS

The object, other features and advantages of the present invention will become more apparent from the description of the preferred embodiments thereof with reference to the accompanying drawings, in which:

FIG. 1 is a block diagram showing the configuration of a conventional digital mobile telephone.

FIG. 2 is a block diagram of a digital mobile telephone for multimedia data according to the present invention.

FIG. 3 is a flow chart of storing method or providing method for multimedia data through an external apparatus according to an embodiment of the present invention.

FIG. 4 is a flow chart of storing method or providing method for multimedia data without an external apparatus according to an embodiment of the present invention.

FIG. 5 is a flow chart of storing or providing multimedia data through an external apparatus according to another embodiment of the present invention.

FIG. 6 is a flow chart of retrieving method for multimedia data stored in a non-volatile memory according to an embodiment of the present invention.

FIG. 7 shows a data format of multimedia data according to an embodiment of the present invention.

FIG. 8 is a flow chart of executing method for multimedia data contents in the mobile telephone according to the present invention.

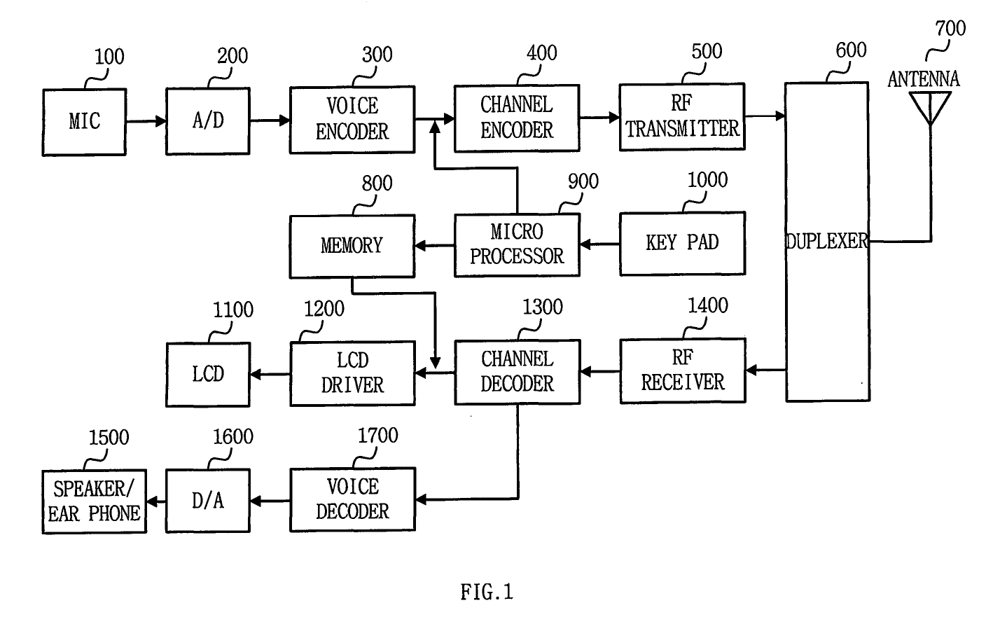

### DESCRIPTION OF THE PREFFERED EMBODIMENTS

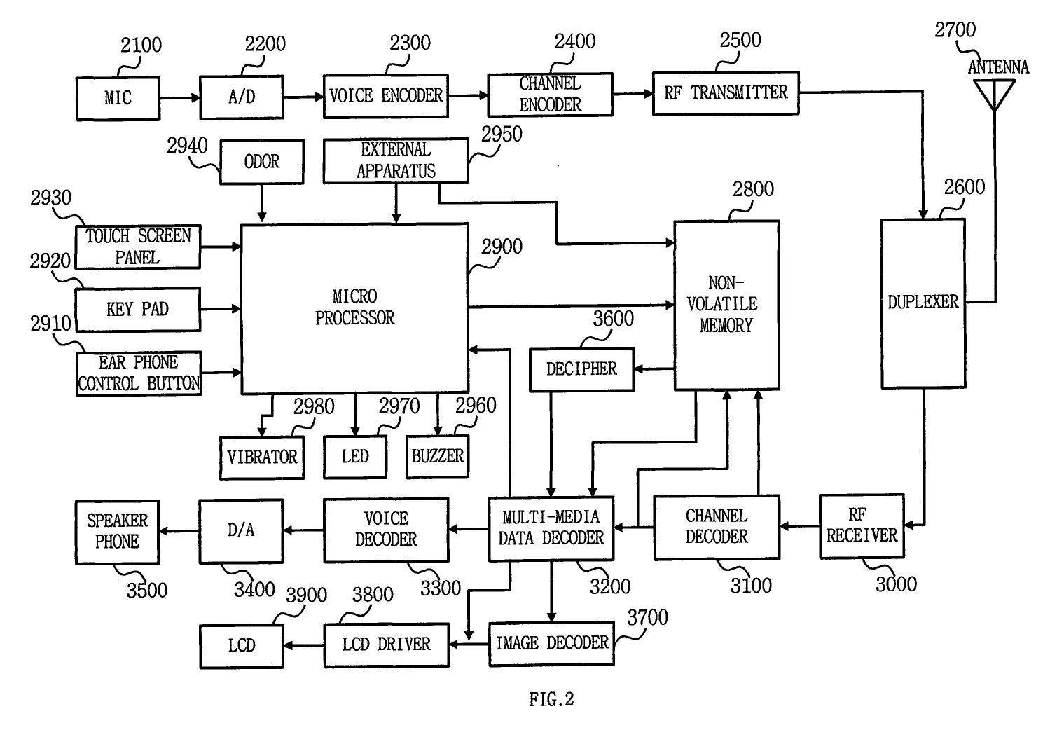

FIG. 2 is a block diagram of a digital mobile telephone of the present invention. The digital mobile telephone is different in the configuration from the prior art in that the former further comprises a multimedia data decoder 3200, a decipher 3600, an odor emitter 2940, and a non-volatile built-in memory 2800 that is detachable from the digital mobile telephone.

Referring to FIG. 2, a channel encoder 2400, a RF transmitter 2500, a duplexer 2600, an antenna 2700, a RF receiver 3000, and a channel decoder 3100 form a data communication means that communicates data with an external device e.g., a mobile communication switch. As apparent to the ordinary skilled in the art, the channel encoder 2400 may be a convolution encoder for correcting errors and the channel decoder 3100 operates oppositely to the channel encoder 2400. The antenna 2700 is to transmit and receive electromagnetic signal, and the RF transmitter 2500 and the RF receiver 300 share a single antenna 2700 through the duplexer 2600. User's input of the digital mobile telephone enters via an input means which includes a microphone 2100, a keypad 2920, a touch screen panel 2930. The multimedia data is stored in a data storing means or memory 2800, and reproduced by a multimedia data reproducing and outputting means which includes a speaker/earphone 3500, an LCD display screen 3900, an odor emitter 2940, a buzzer 2960, LED 2970 and a vibrator 2980. The user input data and the multimedia data are processed by a data processing means which includes an A/D converter 2200, a voice encoder 2300, a D/A converter 3400, a voice decoder 3300, a microprocessor 2900, and a multimedia data decoder 3200. The multimedia data decoder 3200 processes data from the channel decoder 3100 or the decipher 3600 and/or from the memory 2800 and distributes the processed multimedia data to corresponding one of the multimedia data reproducing and outputting means. The multimedia data decoder 3200 can be implemented by hardware, software or the combination of the hardware and software. The decipher 3600 decrypts the multimedia data from the memory 2800 when the data is encrypted, and the voice decoder 3300 and an image decoder 3700 decode voice and image data, respectively. The odor emitter 2940 emits a predetermined odor under the control of the microprocessor 2900. The touch screen panel 2930 is to input data from user by touching the screen installed in the mobile telephone. A touching mean including, but not be limited to, fingers or pens may be used to touch the screen. The earphone control button 2910 controls the volume of voice output via the earphone and the LED 2970 indicates the operational state of the mobile telephone.

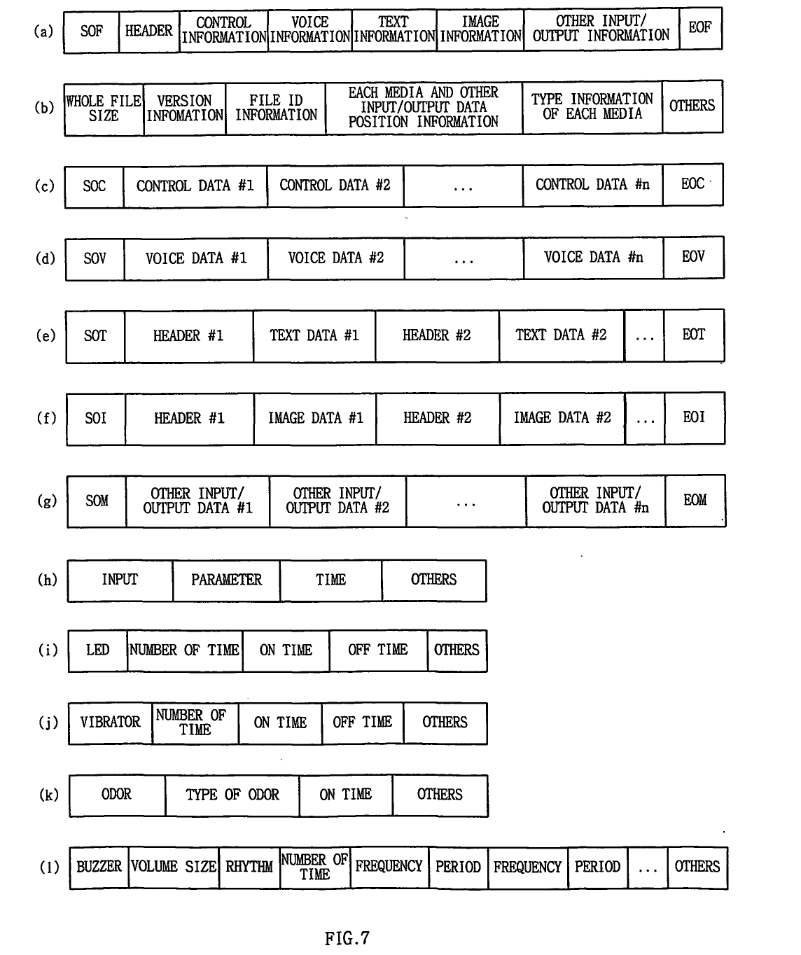

The multimedia data processed in the digital mobile telephone according to the present invention has a header field that comprises a general information sub-field for indicating data total size and a version of each multimedia data file, a media information sub-field for identifying various multimedia data files, a manipulation information sub-field for describing how to process each of the multimedia data files, and a data information sub-field for indicating positions of each of the multimedia data files. Detailed description of the multimedia data format will be given below with reference to FIG. 7.

The configuration and operation of the digital mobile telephone shown in FIG. 2 will be more apparent from the following descriptions on the methods for producing and providing multimedia data for the mobile telephone.

First, methods for storing multimedia data contents into the non-volatile memory in the digital mobile telephone in accordance with the present invention will be described in detail. The storing method corresponds to a method for providing multimedia data contents for the mobile telephone, when viewed from the data provider.

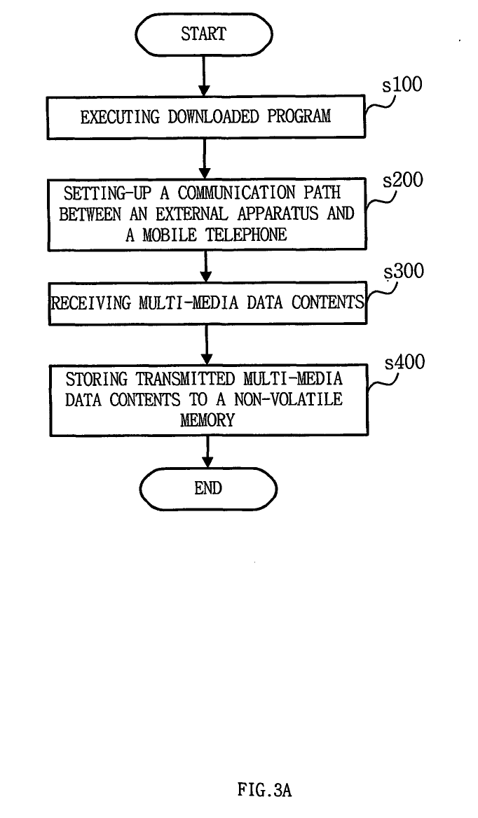

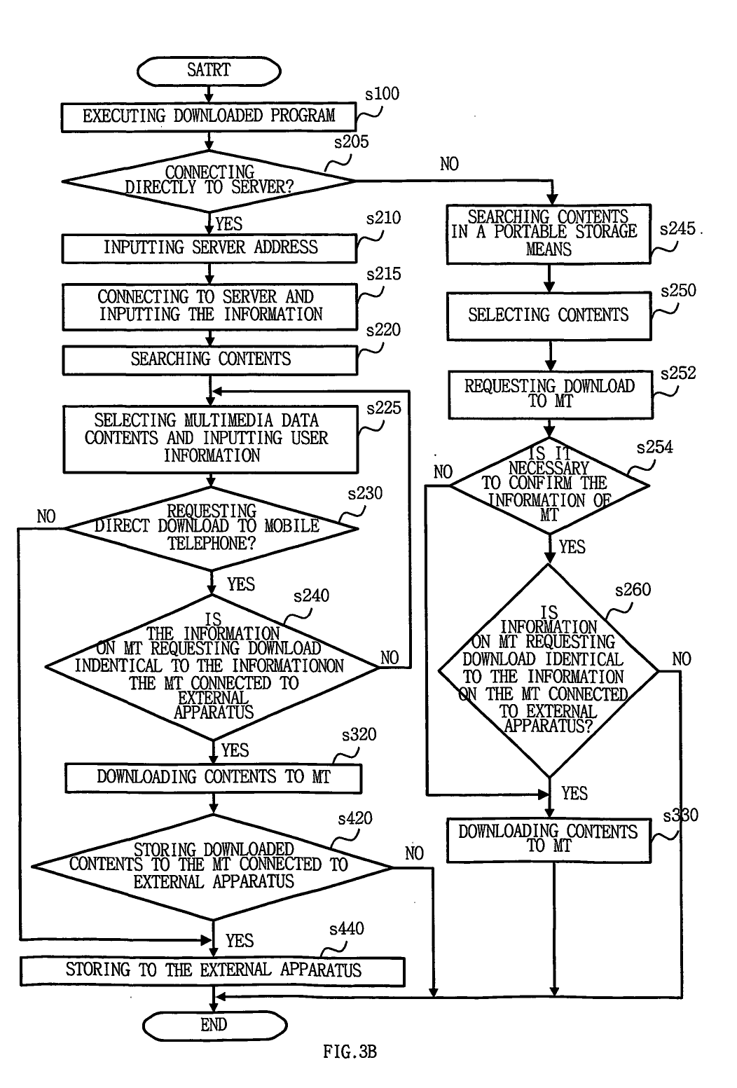

Referring to FIG. 3, a method for storing multimedia data into the digital mobile telephone through an external apparatus (e.g., ‘2950’ in FIG. 2) in accordance with the present invention is disclosed. A method for providing multimedia data for the mobile telephone is illustrated in FIG. 3.

In this embodiment, the external apparatus 2950 receives multimedia data contents provided by one or more service providers through the Internet, a personal computer network, or a portable storing means, and transfers the multimedia data contents into the memory 2800 through the communication with a microprocessor 2900.

The external apparatus 2950 is an electronic device connected to the Internet or PC network by way of wired or wireless communication interface, and the portable storing means is a portable storage media including, but not limited to, a CD-ROM, a DVD, a hard drive, and a diskette. The external apparatus 2950 transmits and receives multimedia data contents to and from the microprocessor 2900 in wired or wireless communication.

This method, as illustrated in FIG. 3a, comprises the steps of executing (s100) a specific downloading program installed or stored in the external apparatus 2950, and setting-up (s200) a communication path between the external apparatus and the microprocessor in the digital mobile telephone, and receiving (s300) the multimedia data contents by using the set-up communication path, and storing (s400) the received multimedia data contents to the non-volatile memory 2800.

More detailed processes are illustrated in the FIG. 3b. Referring to FIG. 3b, the external apparatus 2950 executes the downloading program for the multimedia data contents (s 100), sets-up a communication path between the external apparatus and a microprocessor 2900 (s200), displays information related the multimedia data contents stored in a recording media such as a hard drive, a CD-ROM, a DVD, and a diskette on a window after making the window for a user. Further, the downloading program directly connects the user to a server computer of a data provider if the user inputs the address of the server computer.

Then it is confirmed that if the user directly connects to the Internet server providing the multimedia data contents or not (s205). If the user wants the direct connection, the user inputs the server address (s210) to be connected to the server and inputs his information (s215).

The user searches multimedia data contents from the server (s220) and selects desirable multimedia data contents and requests the selected contents to be downloaded by inputting information of the digital mobile telephone (e.g. telephone number) (s225).

The user checks whether he will immediately download the selected multimedia data contents to the digital mobile telephone or not (s230).

If the user wants to download immediately, at the beginning of the downloading process, the downloading program only determines whether the information of the digital mobile telephone inputted by the user is identical to the information on the mobile telephone that is actually connected to the external apparatus, from which the multimedia data contents are downloaded (s240). After the determination, if the information is not identical to each other, the downloading is not executed and the process goes back to the step (s225).

If the two information are identical to each other, the contents are downloaded to the mobile telephone (s320). Then, it is determined whether the downloaded contents are stored into a portable storage means installed in the external apparatus or not (s420). If the user wants to save the downloaded contents into the external apparatus, the contents are stored into the portable storage means (s440), while if the user does not want, the procedure terminates.

When the user decides not to download the contents immediately at the step of s230, the selected multimedia data contents will be stored to a portable storage means of the external apparatus (s440).

On the other hand, the information already stored in the portable storage means of the external apparatus such as a PC may be searched before the user determines whether connect to the contents provider. That is, based on the result of the confirmation step (s205), if the user does not want the direct connection because the information possibly was already in the portable storage means, then the desirable multimedia data contents from the portable storage means (s245) is searched, and the desirable multimedia data contents (s250) is selected on the external apparatus. In this case, downloading of the selected desirable multimedia data contents will be requested to the portable mobile telephone (s252). Further, the necessity to confirm the information of the mobile telephone according to the request (s254) is checked, and the contents to the mobile telephone is downloaded if the confirmation is not necessary (s330) When the confirmation is necessary, it will be confirmed whether an information of the digital mobile telephone inputted by the user is identical to the information of the mobile telephone connected to the external apparatus, from which the contents are downloaded (s260) if the confirmation is necessary. And, if the information is identical to each other, the content is downloaded to the portable mobile telephone (s330), or the procedure terminates if the information is different from each other.

Moreover, “downloading only” program is executed by external apparatus in an user window and receives the information on the multimedia data contents stored in the portable storage means and the information on the usable memory size of the mobile telephone. Thus downloaded information is provided through the user window. Unnecessary multimedia data contents in the portable mobile telephone can be deleted by performing functions such as storing and deleting. Therefore, it is easy to select preferable contents and download on the window having the above function by using a mouse pointer.

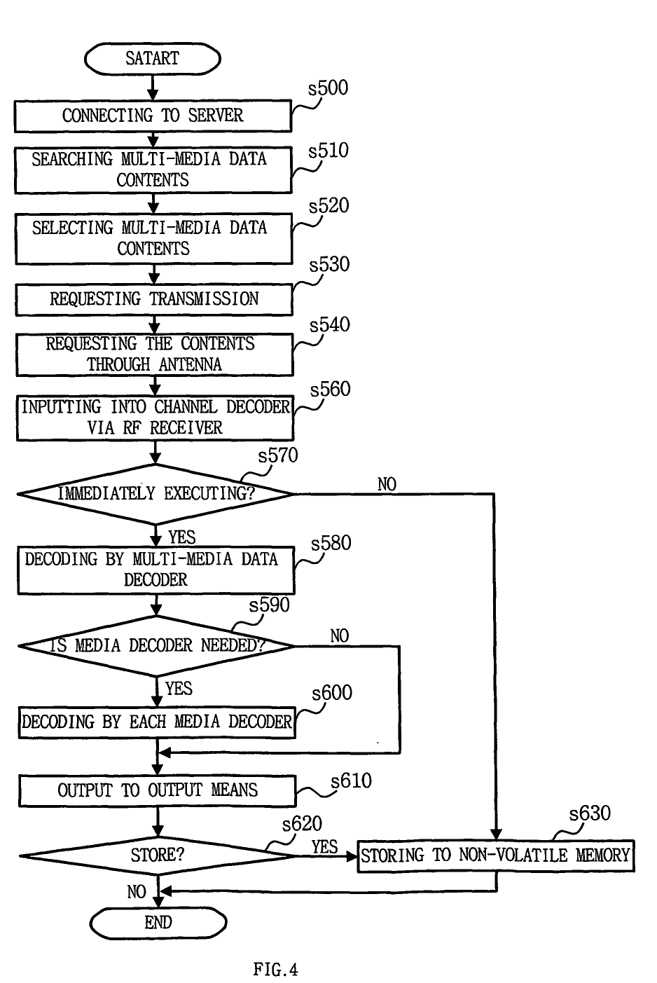

The second embodiment for storing multimedia data contents into a non-volatile memory in a mobile telephone according to the present invention is to receive the multimedia data contents through an antenna 2700 from a contents provider or a mobile telecommunication service provider, and to store the received contents into the non-volatile memory via a RF receiver 3000 and a channel decoder 3100. In FIG. 4, this embodiment is illustrated.

As illustrated in FIG. 4, at first, the user connects to the contents provider's server via Internet by using the digital portable mobile telephone (s500). After connection, the user searches desirable multimedia data contents from the connected server (s510), and selects desirable multimedia data contents (s520), and requests downloading the selected multimedia data contents to the digital mobile telephone (s530).

The requested contents are received by an antenna 2700 via a base station (s540) and inputted into the channel decoder 3100 via the RF receiver 3000 (s560).

After this step, the user confirms whether an output signal of the channel decoder is run immediately or not (s570) and, if the user wants to run it later, stores the output signal of the channel decoder to a non-volatile memory 2800 in the digital mobile telephone (s630) in order to freely retrieve when necessary.

Otherwise, if the user wants to execute immediately, after decoding the output signal of the channel decoder by a multimedia data decoder 3200, the user determines whether a media decoder 3300 and 3700 is needed or not (s590).

If the media decoder 3300 and/or 3700 is needed, the user selects a media decoder to be needed for a voice data or an image data, respectively, and decodes (s600), and outputs the decoded results to an output means (s610).

But, if the media decoder 3300 or 3700 is not needed, the user outputs the decoded data by the multimedia decoder 3200 through an output means 2940, 2960, 2980, or 3900.

After deciding whether the output data from the output means 2940, 2960, 2980 and 3900 is stored or not (s620), the user stores the output data to the non-volatile memory if the user wants to store (s630), or ends the procedure if the user does not want to store. If the inputted data is a text data, the inputted data is not produced through the decoder 3300 but through a relevant output means 3900. The multimedia data contents outputted from the output means 3900 is stored into the non-volatile memory through a step for determining of storing (s620) if the storing is necessary. At this time, the output means including a speaker/earphone 3500, an LCD 3900, a buzzer 2960, an LED 2970, a vibrator 2980, an odor-emitting device 2940 outputs the multimedia data contents.

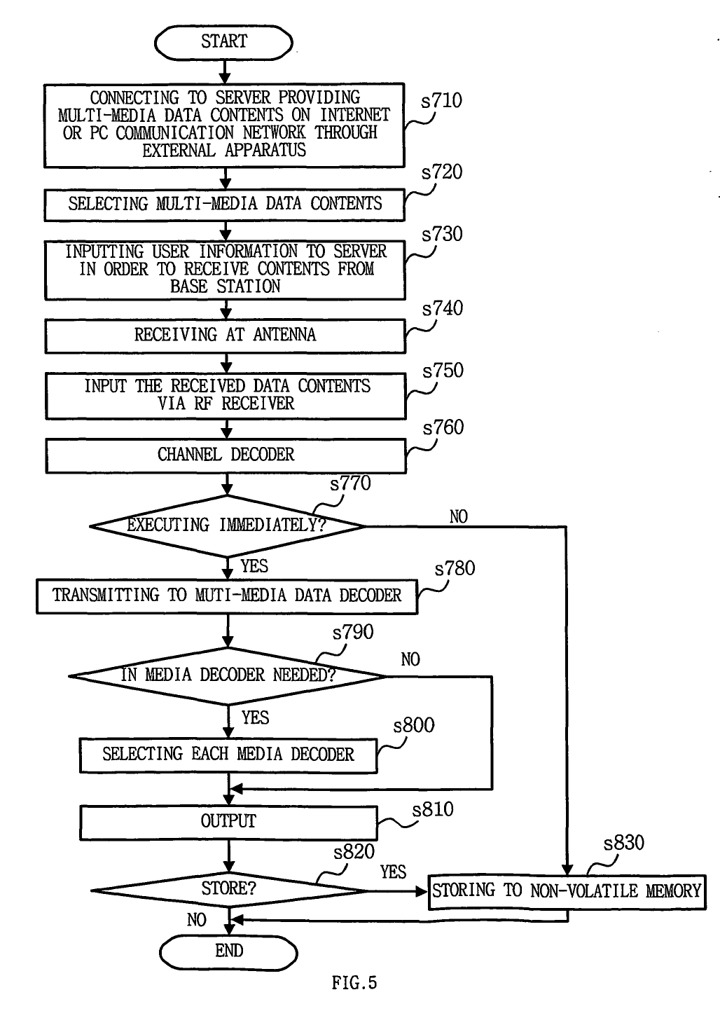

The third embodiment for storing multimedia data contents into a non-volatile memory in a mobile telephone according to the present invention is illustrated in FIG. 5. The method illustrated in the FIG. 5 stores the multimedia data contents into a non-volatile memory in a mobile telephone after receiving the multimedia data contents from Internet or PC communication network.

At first in this method, via an external apparatus 2950, a user connects to a server providing the multimedia data contents on Internet or on the personal computer-based telecommunication network (s710), and selects desirable contents from the server (s720). And the user inputs his information to the server in order to receive the selected contents through an antenna of the base station (s730). And then, he receives the multimedia data contents via the antenna of a mobile telephone in accordance with the inputted information (s740), and inputs the received data contents to a channel decoder via a RF receiver (s750).

After this, the user confirms whether an output signal of the channel decoder will immediately be executed or not (s770). If the user wants to execute it later, he stores (s830) the output signal of the channel decoder to the non-volatile memory (2800) in order to retrieve the stored multimedia data when necessary. Otherwise, if the user wants to execute it immediately, he transmits (s780) the output signal of the channel decoder 3100 to a multimedia data decoder 3200 in order to retrieve the output signal of the channel decoder and confirms whether a media decoder is needed or not (s790).

If the user needs the media decoder, he selects a voice decoder 3300 for voice data and selects an image decoder 3700 for an image data (s800) and outputs the decoded data by the selected media decoder will be generated onto a relevant output means (s810). But, if the data is a text data and the media decoder is not needed, the user outputs directly the decoded data by the channel decoder to a relevant output means without through the media decoder (s810).

After the user determines whether it is necessary to store the output multimedia data contents from the output means (s820), the user may store (s830) the contents into to the non-volatile memory 2800. In this case, the output means including a speaker/earphone 3500, a LCD 3900, a buzzer 2960, or an LED 2970, a vibrator 2980, an odor-emitting device 2940 generates the multimedia data contents.

In the fourth embodiment for storing multimedia data contents into a non-volatile memory of a mobile telephone according to the present invention, a non-volatile memory 2800 having multimedia data contents is installed in a mobile telephone from the outside and the multimedia data contents are received, wherein the memory is removable from the mobile telephone.

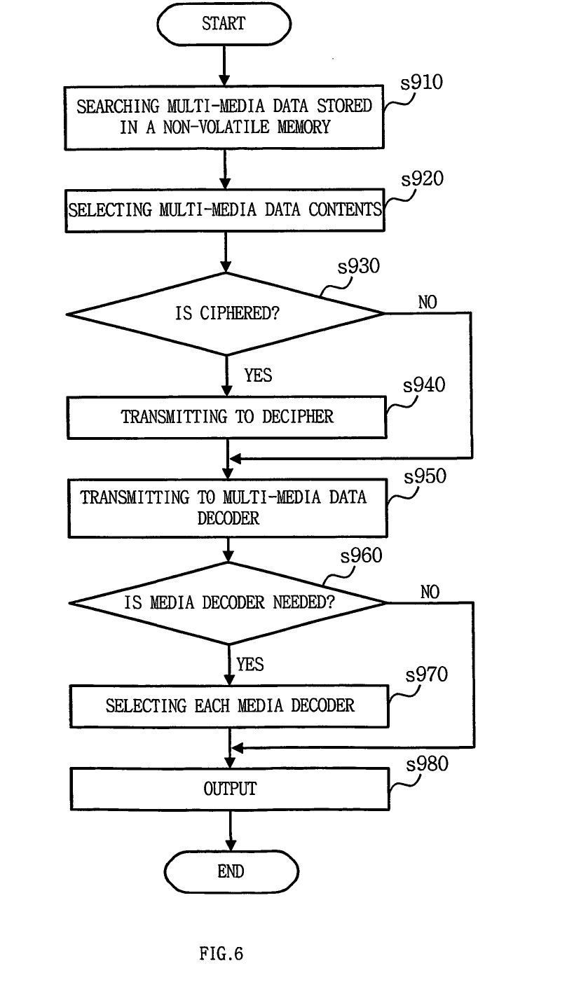

In retrieving the stored multimedia data contents from the non-volatile memory 2800, if the stored contents are ciphered, desirable multimedia data contents are outputted to a relevant output means via a deciphering device 3600. For example, according to the contents of the multimedia data, it is possible to output multimedia data contents to all or part of the output means supported by the mobile telephone as illustrated in FIG. 6.

In the method for retrieving the multimedia data contents stored in the non-volatile memory as illustrated in the FIG. 6, the multimedia data contents stored in the non-volatile memory (s910) are searched and the desirable multimedia data contents (s920) are selected. At this time, the microprocessor checks whether the multimedia data contents are ciphered or not (s930). After the confirmation, if the contents are ciphered, the selected desirable multimedia data is transmitted to a deciphering device 3600 and if the contents are not ciphered, it is transmitted to a multimedia data decoder 3200 (s950). Thereafter, it is determined whether the media decoder is needed or not (s960). For voice and image data contents, a voice decoder 3300 and an image decoder 3700 are selected, respectively (s970) and the contents are outputted through a respective output means (s980). Otherwise, for text data contents, they are directly outputted to the desirable output means without using the media decoder s980. In this case, the output means including a speaker/earphone 3500, an LCD 3900, a buzzer 2960, an LED 2970, a vibrator 2980, or an odor-emitting device 2940 produces the multimedia data contents.

On the other hand, if necessary, a contents service provider may insert an advertisement to the contents.

It is possible to give predetermined reward points to the user when the user watches and or listens to the advertisement through the mobile telephone and to compensate the user for the accumulated points in the form of credit.

Format of the multimedia data according to this invention is described below. FIG. 7a shows an embodiment of the multimedia data formats of this invention. The multimedia data structure may have the following fields: a SoF (Start of File) indicating a starting point of a file, a header, a control information, a voice information, a text information, an image information, other input/output information, an EoF (End of File) indicating an ending point of a file. The field size can be adjusted, if necessary. Here, the voice information, text information field and image information fields are called a payload field.

Each of the fields may be formulated as illustrated in FIGS. 7b to 7g.

FIG. 7b shows the header field. The header field comprises information on the total file size, the version of program or contents, the file ID, the position of each media and input/output data, the type of each media, and other information. The file size sub-field and the version sub-field are called a general information sub-field. The file ID sub-field is referred to as a media information sub-field since it is to identify a plurality of multimedia data files. The position of each media and input/output data sub-field is called a data information sub-field for indicating the positions of each of multimedia data files. The type of each media sub-field is referred to a manipulation information sub-field, indicating how to process each of the multimedia data files.

The total file size sub-field indicates the whole size of a file including the SoF and the EoF. The information on version indicating file's versions and on file's ID having information related the file ID is used for identifying multimedia data files. The position field for each media and other input/output data has information on a starting position of voice data, text data, image data and other input/output data. The type field for each media has information on a vocoder's type and an image data's type. And the header fields may include optional fields that are not displayed in the header but necessary to the file.

FIG. 7c shows the structure of the control information field. The control information field comprises a SoC (Start of Control) field indicating a starting point of the control information, plurality of control data fields, an EoC (End of Control) field indicating an ending point of the control information. In this case, each control data field has a constant field size and information on voice data, text data and image data, respectively, and is repeated every constant time interval. The control data has information on deciding whether there are the text data and the image data to be reproduced to a LCD together with the reproduction of the voice data.

FIG. 7d shows the structure of the voice information field. The voice information field comprises a SoV (Start of Voice) field indicating a starting point of the voice information, a number of voice data fields, an EoV (End of Voice) field indicating an ending point of the control information.

FIG. 7e shows the structure of the text information field. The structure comprises a SoT (Start of Text) field indicating a starting point of the text information, a number of header fields and text data fields next to the SoT, and an EoT (end of text) field indicating an ending point of the text information. Each header field comprises information on size of the text data, and the text data field indicates a text data to be outputted to the LCD.

FIG. 7f shows the structure of the image information field. The structure comprises a SoI (Start of Image) field indicating a starting point of the image information, a number of header fields of the next position of the SoI, and an EoI (End of Image) field indicating an ending point of the image information. Each header field comprises information on size of the image data, and the image data field has an image data to be displayed on the LCD.

FIG. 7g shows the structure of the reserved input/output information field. The structure comprises a SoM (Start of Miscellany) field indicating a starting point of the input/output information, a number of reserved input/output data fields and an EoM (End of Miscellany). The reserved input/output data field takes forms as below in accordance with the type of the input/output

FIG. 7h illustrates the structure of the reserved input/output data field in the case that input is requested. In this case, the reserved input/output data field comprises an input field, a parameter field, time field and reserved fields. The input field has a constant value regardless of the types of the input means such as a keypad, a microphone, a touch screen panel, and an earphone control button. Therefore, it is possible to input a desirable value through any input means. The parameter field designates the range of input value to be inputted by user. The time field designates the maximum time required for inputting value by user. The reserved field is an optional field to be used if the information except the currently referred field is necessary to the file.

FIG. 7i indicates the structure of the reserved input/output data field in the case that output through an LED is requested. In this case, the reserved input/output data field comprises an LED field, a field of the number of times, ON-time field, OFF-time field and reserved fields. The LED field indicates that the output means is the LED and the field of the number of times designates the numbers of flickering of the LED. The ON-time field and the OFF-time field designate on time and off time of the LED respectively. The reserved field is an optional field to be used if the information except currently referred field is necessary to the file.

FIG. 7j indicates the structure of the reserved input/output data field in the case that output through a vibrator is requested. In this case, the reserved input/output data field comprises a vibrator field, a field of the number of times, ON-time field, OFF-time field and other fields. The vibrator field indicates that the output means is the vibrator and the field of the number of times designates the number of vibrating of the vibrator. The ON-time field and the OFF-time field designate on time and off time of the vibrator respectively. The reserved field is an optional field to be used if the information except the currently referred field is necessary to the file.

FIG. 7k indicates the structure of the reserved input/output data field in the case that output through an odor-emitting device is requested. In this case, the reserved input/output data field comprises an odor emitting device field, type of the odor-emitting device, ON-time field and reserved fields. The odor emitting device field indicates the output means is the odor-emitting device and the type field of the odor-emitting device designates types of the odor-emitting device. The ON-time field designates on time of the odor-emitting device. The reserved field is an optional field to be used if the information except the currently referred field is necessary to the file.

FIG. 7l indicates the structure of the reserved input/output data field in the case that output through a buzzer is requested. In this case, the reserved input/output data field comprises a buzzer field, volume size field, rhythm field, a field of the number of times, a number of frequency fields, a number of period fields corresponding to each frequency field, and reserved fields.

The buzzer field indicates that the output means is the buzzer and the volume and rhythm field designate volume and rhythm of the sound emitted from the buzzer respectively. The field of the number of times designates the iteration number of the frequency and the period field. The frequency field designates tones of the sound, and the period field designates length of the sound. The reserved field is an optional field to be used if the information except the currently referred field is necessary to the file.

Although the reserved input/output data field has been explained for a buzzer with reference to FIG. 7l, it is possible to incorporate a reserved input/output data field into other input/output devices, for example, virtual keyboard or screen in the multimedia data format of the present invention. In one embodiment of the present invention, it is possible that the mobile telephone automatically informs to the advertisement service providers, if a user watched and listened to the advertisement, by using a SMS (short messaging service) via non-traffic channels or traffic channels.

As understood from the descriptions with reference to FIGS. 3 to 5 and data format of FIG. 7, the method for providing multimedia data contents of the present invention includes the preparation of multimedia data having a format of payload field and header field by the multimedia data provider. The provider accepts a request from a plurality of mobile telephone users, and receives and processes the users' information. The provider provides a selection function to the users to choose the multimedia data contents and transmits the selected contents to the requesting mobile telephone. The transmission of contents may be performed by direct transfer of the contents to the mobile telephone or indirectly via an external device e.g., a personal computer system of the user.

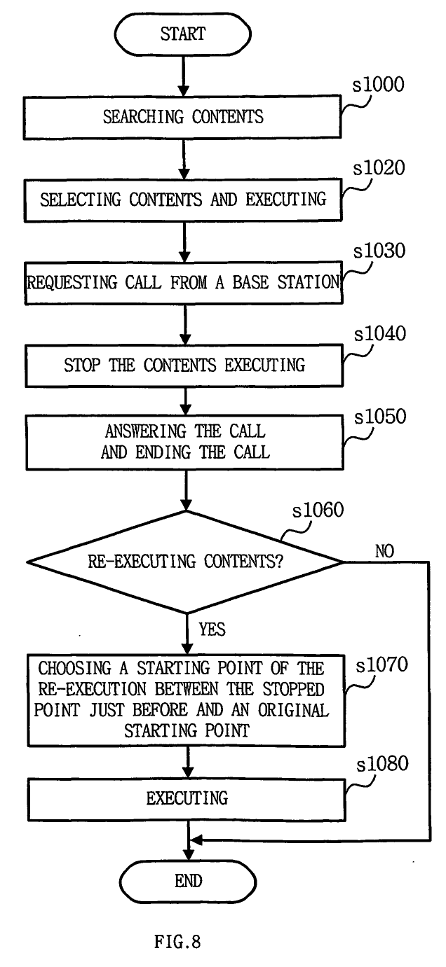

According to other embodiment of the present invention, a method for executing multimedia data contents in a mobile telephone when a call is requested through the base station during the execution of the multimedia data contents in a mobile telephone is illustrated in FIG. 8. The method comprises the steps of (1) searching multimedia data contents (s1000), executing desirable multimedia data content out of the searched contents (s1020); (2) requesting a call by a base station during the execution of the contents (s1030), stopping the execution (s1040), answering to the call (s1050), confirming whether the execution is going on or not if the call is over (s 1060); and (3) ending the procedure if user wants to stop the execution, and, if user wants to the execution, determining whether the re-starting point of the execution is a stopped point just before or a starting point of the contents (s1070), and executing the contents in accordance with the determination (s1080).

As described in the above, the present invention discloses plurality of methods for storing the multimedia data contents using a combined multimedia data format into the non-volatile memory of a mobile telephone. The present invention also discloses a method to retrieve and output the desirable contents through output means supported by the mobile telephone when necessary. The present invention also discloses a method to interact among the users of the mobile telephone and the contents by using the input means supplied by the mobile telephone. A benefit of the present invention is that it is possible to store data effectively in a relatively small quantity of memory if compressed data is used for each media, which constitutes the multimedia data.

Although the preferred embodiments of the present invention have been described and illustrated in detail, it will be evident to those skilled in the art that various modifications and changes may be made thereto without departing from the spirit and the scope of the invention as set forth in the appended claims and equivalents thereof.

What is claimed is:

1. A digital mobile telephone for processing electrical signals for mobile telephone communication and adapted to reproduce multimedia data, said digital mobile telephone comprising:
data communication means for transmitting to and receiving from an external communication device, said data communication means including an antenna, an RF transmitter, a channel encoder, an RF receiver, a channel decoder and a duplexer;
input means for receiving an user's instructions, said input means including a key pad and a microphone;
multimedia data storing means for storing said multimedia data contents;
a plurality of multimedia data reproducing and outputting means for retrieving said multimedia data and including a loudspeaker and a display screen; and
data processing means including an A/D converter, a voice encoder, a D/A converter, a voice decoder, a microprocessor, and a multimedia data decoder,
wherein, said multimedia data is of a format having a header field which comprises a general information sub-field for indicating data total size and a version of each multimedia data file, a media information sub-field for identifying various multimedia data files, a manipulation information sub-field for describing how to process each of the multimedia data files, and a data information sub-field for indicating positions of each of the multimedia data files; and
said multimedia data decoder processes the multimedia data from the channel decoder and/or from the multimedia data storing means and distributes the processed multimedia data to corresponding one of the multimedia data reproducing and outputting means.

2. The digital mobile telephone of claim 1, wherein the multimedia data decoder is implemented in a form selected from the group consisting of software, hardware and a combination of the software and hardware.

3. The digital mobile telephone of claim 1, wherein the multimedia data reproducing and outputting means further comprises a decipher for deciphering the multimedia data from the multimedia data storing means, when the multimedia data are encrypted.

4. The digital mobile telephone of claim 1, wherein the multimedia data reproducing and outputting means further comprises at least one selected from the group consisting of an odor-emitting device for making and emitting odor under control of the microprocessor, a light emitting device installed in the digital mobile telephone for displaying status of the digital mobile telephone, a buzzer provided within the digital mobile telephone for emitting audible sound signals, and a vibrator for producing a vibration signal.

5. The digital mobile telephone of claim 1, wherein said format of the multimedia data further comprises a control information field including sub-fields of SoC (Start of Control), EoC (End of Control), and data control, said data control sub-field having an information on reproduction of one of the multimedia data together with other multimedia data.

6. The digital mobile telephone of claim 5, wherein said format of the multimedia data further comprises a payload field including at least one selected from the group consisting of a voice information sub-field having voice data, a text information sub-field having at least one header and text data corresponding to the associated header, an image information sub-field having at least one header and image data corresponding to the associated header.

7. The digital mobile telephone of claim 1, wherein the multimedia data storing means is selectively detachable to and from the digital mobile telephone.

8. A method for providing multimedia data contents for use in a digital mobile telephone, said method comprising steps of:
preparing multimedia data contents of a format having a header field and a payload field having a plurality of multimedia data, said header field having a general information sub-field for indicating data total size and a version of each multimedia data file, a media information sub-field for identifying various multimedia data files, a manipulation information sub-field for describing how to process each of the multimedia data files, and a data information sub-field for indicating positions of each of the multimedia data files;
receiving a request for the multimedia data contents from a plurality of digital mobile telephones;
receiving and processing an user information from the requesting digital mobile telephone;
supplying a selection function for the digital mobile telephones to choose at least one of the multimedia data contents; and
transmitting to the requesting digital mobile telephone the multimedia data contents chosen and modified on the basis of an information regarding the requesting mobile telephone.

9. The method for providing multimedia data contents of claim 8, wherein the step of transmitting the multimedia data contents comprises steps of transmitting the multimedia data contents to an external device so that the transmitted multimedia data contents can be delivered to the digital mobile telephones by the external device.

10. The method for providing multimedia data contents of claim 9, wherein said external device includes a personal computer.

11. The method for providing multimedia data contents of claim 8, wherein the step of transmitting the multimedia data contents sends the multimedia data contents directly to the requesting digital mobile telephone.

12. The method for providing multimedia data contents of claim 11, wherein the step of receiving and processing an user information is performed by receiving the user information and a mobile telephone information from an external apparatus, and the step of transmitting the multimedia data contents includes the step of determining whether the mobile telephone information received from the external apparatus is correct.

13. The method for providing multimedia data contents of claim 8, wherein the information regarding the requesting mobile telephone includes data indicating usable memory size of the digital mobile telephone.

14. The method for providing multimedia data contents of claim 8, wherein the multimedia data contents contains an advertisement data.

15. The method for providing multimedia data contents of claim 14 further comprising steps of giving predetermined reward points to the digital mobile telephones when the advertisement data is sent to and retrieved by the digital mobile telephone.

16. The method for providing multimedia data contents of claim 8, wherein the payload field comprises at least one selected from the group consisting of a voice information sub-field having voice data, a text information sub-field having at least one header and text data corresponding to the associated header, and an image information sub-field having at least one header and image data corresponding to the associated header.

17. A method for executing multimedia data contents in a mobile telephone, said method comprising the steps of:
searching and selecting the multimedia data contents;
executing selected multimedia data contents;
pausing the execution when a call request by a base station occurs during the execution;
answering to the call;
deciding whether said execution is going on or not if the call is over;
terminating if the user wants to stop the execution, and, if the user wants the execution,
determining whether the re-starting point of the execution is a paused point just before or an original starting point of the contents; and
executing the contents in accordance with the determination.

18. The method as set forth in claim 17, wherein the mobile telephone has a non-volatile, built-in memory, said memory being detachable from the mobile telephone.
